(19) United States
(12) Patent Application Publication
(10) Pub. No.: US 2020/0164921 A1
(43) Pub. Date: May 28, 2020

(54) Device for Modifying Lateral Control of a Vehicle

(71) Applicant: Bayerische Motoren Werke Aktiengesellschaft, Muenchen (DE)

(72) Inventor: Alexander AUGST, Muenchen (DE)

(21) Appl. No.: 16/778,157

(22) Filed: Jan. 31, 2020

Related U.S. Application Data
(63) Continuation of application No. PCT/EP2018/070663, filed on Jul. 31, 2018.

(30) Foreign Application Priority Data
Aug. 1, 2017 (DE) 10 2017 213 207.8

(51) Int. Cl. B62D 15/02; G05D 1/00; G08G 1/01

(52) U.S. Cl. CPC B62D 15/025; G08G 1/0125; G05D 1/0088

(57) ABSTRACT

A device for modifying the lateral control of a vehicle designed for at least partially automated driving includes an accelerator pedal and/or a brake pedal. The device is designed to execute, prevent or influence an automated lateral control action of the vehicle during operation of the vehicle when the accelerator pedal and/or the brake pedal is operated, depending on a vehicle driving variable representing the degree of automation.

### CROSS REFERENCE TO RELATED APPLICATIONS

This application is a continuation of PCT International Application No. PCT/EP2018/070663, filed Jul. 31, 2018, which claims priority under 35 U.S.C. § 119 from German Patent Application No. 10 2017 213 207.8, filed Aug. 1, 2017, the entire disclosures of which are herein expressly incorporated by reference.

### BACKGROUND AND SUMMARY OF THE INVENTION

The invention relates to a device for modifying lateral control of a vehicle, in particular by way of pedal operation. Furthermore, the invention relates to a vehicle configured for at least partly automated driving, and to a pedal system of such a vehicle. Furthermore, the invention relates to a corresponding method and a computer program product for modifying lateral control of a vehicle, in particular by way of pedal operation.

At present the pedals of a vehicle are utilized exclusively for influencing the longitudinal control of the vehicle in a targeted manner. Pedals of the vehicle are also correspondingly movable in the driving direction of the vehicle and downward. They have only one degree of freedom, typically a pedal angle, which is varied as the pedal is operated by the driver in order thereby to influence the longitudinal control of the vehicle. Lateral control or the steering of the vehicle is effected by means of a steering wheel or steering assembly of the vehicle. Human feet, with regard to their movement in a transverse direction, do not have sufficiently well-developed or proficient fine motor skills to allow such movement to be used to prescribe the lateral control of the vehicle sufficiently precisely and conveniently using the feet.

Furthermore, driver assistance systems are known which assist the driver in the longitudinal control of the vehicle or in the lateral control of the vehicle. By way of example, numerous variants of distance-dependent speed regulating functions (adaptive cruise control) and of a steering assistant or a congestion assistant are known. Such driver assistance functions can actively intervene in the longitudinal control of the vehicle or at least partly take over the longitudinal control. Driver assistance functions are also known which actively intervene in the lateral control of the vehicle or at least partly take over the lateral control. Furthermore, driver assistance functions can also perform a large number of the driving tasks through to highly automated or automatic driving. Such systems offer in part a highly variable degree of automation. The (actually utilizable) degree of automation may additionally vary significantly within a segment on account of diverse boundary conditions.

Furthermore, so-called highly automated driving is envisaged, which should take over a considerable proportion of driving tasks through to fully automated driving. Highly automated driving systems of a vehicle are known at present in a form such that the automated driving is switched off in the event of the driver making significant interventions in the control of the vehicle. By way of example, if the vehicle automatically regulates a speed to be maintained depending on the traffic ahead, then the automated driving function is switched off as a result of the actuation of the brake by the driver. These properties are known in association with safety, e.g. in the case of an unsafe state or functioning of the driving function that is not in line with the driver's expectation, but also owing to an as yet not fully developed set of regulations in respect of accepting responsibility in the case of an accident, the driver of such a vehicle must therefore be able to take over control of the vehicle within a short time.

On account of the boundary conditions which undergo great change spatially and temporally and which have to be satisfied for automated driving operation of a motor vehicle, the driving experience for the driver can amount to a large number of changing phases with and without driving automation. Moreover, the requirement for drivers to participate interactively in the driving of the vehicle within the automated driving is not sufficiently satisfied.

There is a need for a coherent solution for concomitant control of a vehicle with at least partly automated longitudinal control and/or lateral control by the driver, e.g. for the case where the driver must take over or would like to take over at least the longitudinal control or the lateral control of the vehicle in a short time, preferably such that this results in the driver assistance function being switched off or interrupted. Furthermore, the object of the invention is to free the driver's hands of the driving tasks to the greatest possible extent—even in the case of vehicles or driving segments which do not allow full-fledged highly automated drivers.

The invention provides a device for modifying the lateral control of a vehicle configured for at least partly automated driving, wherein the device comprises an accelerator pedal and/or a brake pedal and the device is configured to execute, prevent or influence an automated lateral control action of the vehicle during operation of the vehicle upon actuation of the accelerator pedal and/or the brake pedal depending on a variable of the travel of the vehicle, said variable representing the degree of automation.

Preferably, the at least one lateral control action of the vehicle is a driving maneuver of the vehicle comprising lateral control, i.e. the automated lateral control action is part of a driving maneuver or part of a determined driving maneuver comprising lateral control of the vehicle.

Advantageously, executing a driving maneuver (defined above) comprising an automated lateral control action of the vehicle can be carried out depending on at least one first operator control process.

Advantageously, the automated lateral control action can be determined dependent on a variable of the travel of the vehicle, said variable representing the degree of automation, and at least one first condition and/or at least one second condition. If—as already described above—the automated lateral control action is part of a determined driving maneuver (comprising lateral control), in a further advantageous configuration of the invention the type of driving maneuver to be determined can be determined depending on a variable of the travel of the vehicle, said variable representing the degree of automation, and at least one first condition and/or at least one second condition.

In a further advantageous development of the invention, when the at least one second condition is present, said automated lateral control action, in particular the determined driving maneuver of the vehicle comprising lateral control, can be prevented, interrupted or executed in a modified form (if appropriate in a succeeding time interval).

In a further advantageous configuration of the invention, the device can be configured, in response to an actuation of the accelerator pedal or the brake pedal in a first time interval, to execute, prevent or influence at least one automated lateral control action of the vehicle, in particular lane guidance of the vehicle or positioning of the vehicle relative to one or more lane markings or roadway boundaries, during a second time interval, wherein the second time interval is after the first time interval.

Advantageously, the device can have a driving mode for modifying the lateral control of the vehicle on account of the actuation of the accelerator pedal and/or the brake pedal, and the vehicle or the device can be configured in such a way that a transition to said driving mode for modifying the lateral control of the vehicle with an accelerator pedal and/or the brake pedal is effected depending on the at least one variable representing the degree of automation and/or at least one first condition and/or the at least one second condition.

Furthermore, it is pointed out that the at least one first condition and/or the second condition or the quantitative values taken as a basis for the corresponding first condition and/or second condition for the accelerator pedal and the brake pedal can be different.

In the context of this description, the variable representing the degree of automation can be a current degree of automation or a degree of automation determined for the near future (1-30 seconds).

By way of example, the variable representing the degree of automation can be assumed to be high if the degree of automation rises and has exceeded a determined measure, and/or can be assumed to be low if said degree of automation falls and has undershot a predetermined measure. Particularly preferably, a measure of the degree of automation accumulated over time can be taken into account.

Measures or category values defined according to the German Association of the Automotive Industry (VDA) can be applicable as the variable representing the degree of automation. Furthermore, part of the invention encompasses the fact that the variable representing the degree of automation takes account of determined aspects of the achievable or suitable degree of automation individually, selectively or in determined combinations. By way of example, a travel variable representing the degree of automation can also be selective, with regard to at least two different aspects of the automation of the movement of the vehicle and/or for two or more different driver assistance functions of the vehicle in the control unit, e.g. with regard to: longitudinal control of the vehicle and/or lateral control of the vehicle and/or carrying out a lane change and/or carrying out an overtaking process and/or driver information, in particular in connection with the control of the vehicle.

In this case, all described features of the invention can be applied separately and differently for different aspects of automation.

The variable representing the degree of automation can also be ascertained and/or taken into account depending on the driver's stipulations and/or on a stored operator control history on the part of the driver and/or on parameters or further expedient criteria (e.g. road type, etc.) that are stored in a backend and are retrievable by the vehicle.

Particularly preferably, the device according to the invention is configured for ascertaining a vehicle variable representing the degree of automation for the current degree of automation, applicable in particular in the time interval of +/−2 seconds, and/or for the, e.g. predicted or desired, degree of automation applicable in the near future of approximately 1-30 seconds. In particular, the device can be configured for ascertaining, in particular reading in, a measure of the degree of automation from further devices within or outside the vehicle.

The device can comprise e.g. one or more measures for executing, for instigating and/or for modifying an at least partly executable driving maneuver. By way of example, the device can comprise a unit for at least partly automated driving or can be configured to control such a unit. By way of example, the device can comprise a pedal module designed to generate control signals, wherein the at least one lateral control action of the vehicle is instigated, prevented or influenced (in a determined manner) depending on the control signals. The pedal system and/or the at least one pedal of the pedal system are/is preferably a pedal of the vehicle which, in a substantially manual driving mode of the vehicle, serves for longitudinal control of the vehicle, in particular for controlling or prescribing a driver's desire regarding a vehicle acceleration. As an exception, the device can comprise only one pedal or one operator control element operable by a foot of the driver, or can be configured as a single pedal or some other operator control element operable by the foot of the driver. By way of example, such an operator control element can function as an accelerator pedal within a first actuation range (e.g. a pedal angle range) and/or within a first certain time interval, and as a brake pedal within a second actuation range (e.g. a pedal angle range) and/or within a certain time interval.

The accelerator pedal and/or the brake pedal can be pedals that are mechanically movable substantially only by one degree of freedom. In particular, the accelerator pedal and/or the brake pedal are configured for performing a movement within the XZ-plane in the vehicle coordinates, without for instance a movement in the X-direction, transversely with respect to the orientation of the vehicle.

Preferably, a lateral control action, in particular a determined lateral control action, can be executed in response to an actuation, in particular in response to a determined actuation of the accelerator pedal and/or brake pedal depending on a variable representing the degree of automation. Preferably, said lateral control action can be instigated without or with a longitudinal control action of the vehicle that is to be executed at least partly, in particular substantially simultaneously or in a manner offset in time.

Particularly preferably, in this case, the ratio of the lateral control action and the longitudinal control action can correspond to a predefined mathematical ratio. The mathematical ratio can comprise for example one or more—qualitatively or quantitatively different—variants. The ratio of the lateral control action and the longitudinal control action or said mathematical relationship can be applicable here from an identified and/or predicted traffic situation, e.g. in relation to at least one time interval or one roadway section. By way of example, the ratio of the lateral control action and the longitudinal control action can represent a determined time offset in which the at least one instigated, suppressed or influenced lateral control action and longitudinal control action are executed.

Furthermore, in response to different actuations of the accelerator pedal and/or the brake pedal, different, e.g. including opposing, driving maneuvers comprising automated lateral control actions of the vehicle can be executed. By way of example, depending on an actuation of the accelerator pedal or brake pedal, a direction of a substantially automated evasive maneuver can be determined.

By way of example, given the presence of a vehicle ahead, in particular given a risk—exceeding a certain measure—of collision with a vehicle ahead, depending on an actuation of the accelerator pedal:

a substantially automated evasive maneuver or an overtaking maneuver, in particular in the direction of a faster lane (toward the left in the case of traffic driving on the right), can be made possible or instigated, and/or

depending on whether or not said faster lane is a lane for oncoming traffic, an overtaking maneuver or an evasive maneuver can be executed.

Alternatively or additionally, upon an actuation of the brake pedal,

a substantially automated evasive maneuver or an overtaking maneuver can be suppressed, and/or

an evasive maneuver toward the right or in the direction of a slower driving lane (toward the right in the case of traffic driving on the right) can be executed, and/or

an evasive maneuver or a lane change maneuver can be executed instead of an overtaking maneuver.

In particular, different actuations of the accelerator pedal and/or the brake pedal can determine a set or list comprising one or more determined driving maneuvers which can thereupon be executed by way of means of the vehicle, and/or a or set or list comprising one or more determined executable driving maneuvers which are thereupon prevented or modified. In this case, means of the vehicle can be used to select and/or execute a driving maneuver that is actually to be executed.

With regard to the evaluation of the (different) actuations of the accelerator pedal and/or brake pedal, determined pressure patterns and/or pressure sequences can also be taken into account. Preference is given to recognizing at least one actuation of the accelerator pedal and/or the brake pedal or a differentiation of at least two types of actuation of the accelerator pedal and/or brake pedal by means of pattern recognition. In this case, the pattern recognition can be applied to at least one parameter, preferably to at least two parameters, of the actuation of the operator control element, for example to pedal angle, pedal pressure, or to a time-dependent function, e.g. the time profile of the pedal angle or the pedal pressure. Furthermore, it is possible to recognize at least one actuation of the accelerator pedal and/or the brake pedal or a differentiation of at least two types of actuation of the accelerator pedal and/or brake pedal on the basis of a determined pressure sequence. By way of example, on the basis of the recognition of a determined pattern or pressure sequence, a determined meaning of the operation of the accelerator pedal and/or the brake pedal is identified if the vehicle is in a mode with modified meaning of the pedal operation and/or in a partly automated mode.

By way of example, in a partly automated mode or in a highly automated mode, actuation of the accelerator pedal and/or brake pedal twice or three times can be allocated a determined meaning. By way of example, in this case, a meaning is allocated which differs (in principle) for instance from a meaning of the actuation of the accelerator pedal and/or the brake pedal in a substantially manual mode.

Particularly preferably, an actuation of the accelerator pedal and brake pedal in a determined order and/or sequence and/or at least partly simultaneous actuation of the accelerator pedal and the brake pedal, in particular simultaneous actuation of the accelerator pedal and/or brake pedal, can have the effect that determined parameter limits corresponding to a determined meaning are exceeded. By way of example, simultaneous actuation of the accelerator pedal and brake pedal can lead to a handover of the execution, e.g. to the handover of control of the execution of at least one driving maneuver, in particular of a determined or an imminent driving maneuver, to the vehicle and/or to a handover of control of the execution of at least one determined or one imminent driving maneuver by the driver. In other words, with a determined actuation or a pattern of the actuation of the accelerator pedal and/or the brake pedal, a driving mode can be altered, e.g. it is possible to switch between the at least two driving modes mentioned, e.g. to “shift up” or “shift down”. In this case, with a determined pattern of the actuation of the accelerator pedal and/or the brake pedal, a degree of automation desired by the driver or a determined alteration of the degree of automation can also be predefinable.

In the context of the present document, the term “driving maneuver” should be understood in particular as a driving maneuver of the vehicle that comprises lateral control or a lateral control action. Modifying the lateral control can be executing, preventing or influencing a lateral control action or a driving maneuver which comprises lateral control and which is effected or is intended to be effected, if appropriate, depending on further criteria, e.g. depending on the current traffic conditions.

The lateral control action and/or the driving maneuver comprising lateral control can be executed in relation to one or more lane markings, movable or immobile objects, in particular objects of a determined type in the vicinity of the vehicle, in a substantially automated manner, e.g. by way of means of the vehicle. By way of example, if the at least one variable representing the degree of automation exceeds a determined threshold value and an, in particular a determined, actuation of the accelerator pedal and/or the brake pedal is detected, it is possible to execute the driving maneuver comprising said lateral control action and/or the driving maneuver comprising the lateral control (e.g. an overtaking operation, evasive operation, filtering operation) in relation to another motor vehicle, a cyclist, a pedestrian, etc.

A lateral control action can be an altered orientation and/or guidance of the vehicle in relation to at least one lane marking in the vicinity of the vehicle. By way of example, in this case, it is possible to modify, in particular adapt, the lateral control of the vehicle with respect (in relation) to the lane markings or to a lane center or with respect to a sequence of position values, e.g. to a sequence of position values substantially along the direction of travel, in a global coordinate system.

Furthermore, preventing the lateral control action or a determined maneuver comprising lateral control can relate to an at least partly automated lateral control action or to a corresponding driving maneuver which (under the same boundary conditions) would have been executed if the accelerator pedal and/or brake pedal had not been actuated.

Influencing the lateral control action or a driving maneuver comprising the lateral control can comprise in particular an alteration of one or more parameters of the lateral control action or of the driving maneuver comprising the lateral control which has to be effected in response to the actuation of the accelerator pedal and/or brake pedal (in a succeeding time interval). By way of example, if the driver actuates the brake pedal, a lane change maneuver can be executed instead of an overtaking maneuver. Alternatively or additionally, if the driver actuates the accelerator pedal, an overtaking maneuver can be executed instead of a lane change maneuver.

If—as already described above—the automated lateral control action is part of a determined driving maneuver comprising lateral control, in a further advantageous configuration of the invention the type of driving maneuver to be determined and/or the automated lateral control action can be determined depending on a variable of the travel of the vehicle, said variable representing the degree of automation, and at least one first condition and/or at least one second condition.

To put it another way, depending on the type and/or magnitude of the at least one variable of the travel of the vehicle, said variable representing the degree of automation, and at least one first condition and/or at least one second condition (even upon the same actuation of the accelerator pedal or the brake pedal), different driving maneuvers, in particular different types of driving maneuvers, can be instigated, prevented or influenced. In this case, even within said driving mode for modifying the lateral control of the vehicle, different types of driving maneuvers can be instigated, prevented or influenced. By way of example, different types of driving maneuvers can in each case be predefined depending on one or more parameters of the actuation of the accelerator pedal and/or the brake pedal.

In a further advantageous development of the invention—as has already been explained above—when the at least one second condition is present, said automated lateral control action, in particular the determined driving maneuver of the vehicle comprising lateral control, can be prevented, interrupted or executed in a modified form (if appropriate in a succeeding time interval).

In a greatly simplified example, depending on a determine actuation, e.g. a pressure on an accelerator pedal exceeding a certain value, or upon an accelerator pedal actuation corresponding to a pattern, a lane change operation implementable in an at least partly automated manner or a filtering operation in the direction of a faster lane of the roadway is instigated in a succeeding time interval. In a further example, depending on a pressure on a brake pedal exceeding a certain value, a lane change operation implementable in an at least partly automated manner or a filtering operation in the direction of a slower lane of the roadway is instigated in a succeeding time interval. In this case, e.g. said lane change operation and/or the filtering operation can only be implemented in a time interval succeeding the actuation of the at least one pedal. In particular, the at least one lane change operation or filtering operation is only implemented or begun approximately 5, 15, 30, 60 or 120 seconds after the actuation of the operator control element.

In a further advantageous configuration of the invention, in response to an actuation of the accelerator pedal or the brake pedal in a first time interval, at least one automated lateral control action of the vehicle, in particular lane guidance of the vehicle or positioning of the vehicle relative to one or more lane markings or roadway boundaries, can be executed, prevented or influenced during a second time interval, wherein the second time interval is after the first time interval.

In this case, the second, later time interval should be understood as a time interval which immediately directly follows the first time interval or begins later after the first time interval. By way of example, a few seconds or minutes may elapse after the actuation of the accelerator pedal or the brake pedal in a first time interval. It is only in a succeeding second time interval that the relevant lateral control action identified as a result of the actuation of the accelerator pedal or brake pedal is executed, prevented or influenced.

The abovementioned position or positioning of the vehicle relative to one or more lane lines can comprise in particular a so-called transverse deviation (offset, lateral offset) and/or an angle value. By way of example, in response to an actuation of the accelerator pedal and/or the brake pedal, an altered offset and/or angle value, e.g. an angle value at which a lane marking is overshot, can be determined or altered. A roadway boundary can be e.g. a crash barrier (detectable by way of means of the vehicle) and/or a lateral boundary of the roadway, e.g. a so-called grass verge.

Preferably, an actuation of the accelerator pedal and/or brake pedal does not immediately affect or does not only affect lateral control of the vehicle. An actuation of the accelerator pedal and/or the brake pedal can instigate a defined effect on the lateral control, e.g. on one or more determined lateral control actions, on a maneuver—comprising one or more lateral control elements—or on an at least partly (substantially) automated movement of the vehicle, which is executed, prevented or influenced with the passage of time or in an upcoming time segment or driving segment. If appropriate, further predetermined conditions can also be taken into account here.

Particularly preferably, an actuation of the accelerator pedal and/or brake pedal affects the lateral control of the vehicle within a future time interval in which an actuation is not effected or need not be effected (any more).

By way of example, if the at least one pedal is actuated after a determined threshold value of the variable representing the degree of automation has been exceeded, a modification or influencing of at least partly or substantially automated longitudinal control and/or of partly or substantially automated lateral control of the vehicle can thereupon be effected in a succeeding time interval, for example in a time interval of approximately 5, 10, 30, 60 or 120 seconds or in the sense of a time interval within an upcoming driving segment of approximately 25, 50, 100, 200, 400 or 800 meters, wherein the accelerator pedal and/or the brake pedal need no longer be actuated or need not necessarily be actuated during this time interval or the driving segment.

In other words, the device is configured, depending on a variable representing the degree of automation and the at least one first condition and/or one second condition, to detect an actuation of the accelerator pedal and/or the brake pedal in a first time interval and thereupon to execute an at least partly automated lateral control action of the vehicle in an upcoming second time interval and/or within a suitable driving segment (in a manner appropriate to the traffic conditions).

By way of example, within such a second time interval or the second driving segment even after an interim lateral control action of the vehicle in the direction of a slower driving lane, e.g. owing to an object in the vicinity of the vehicle, a different—if appropriate opposing—lateral control action of the vehicle can be executed, e.g. in the direction of a faster driving lane. The lateral control action is then effected e.g. on account of or on the basis of the actuation of the accelerator pedal and/or the brake pedal in a first time interval preceding the second time interval or the corresponding second driving segment. In another example, within such a time interval or the driving segment after an interim automated lane change maneuver in one direction, e.g. owing to a vehicle to be overtaken or a faster vehicle traveling behind the vehicle, a lane change maneuver of the vehicle in an opposite direction can be executed in a second time interval. The second lane change operation is then effected e.g. on account of or on the basis of the actuation of the brake pedal by the driver already in a first time interval preceding the time interval or the driving segment.

Preferably, the actuation of the accelerator pedal and/or the brake pedal affects the lateral control of the vehicle for a determined time interval and/or a determined driving segment. In particular, the influence of the actuation of the at least one pedal is restricted to a (determined) time interval and/or a (determined) driving segment. The time interval and/or the driving segment can be chosen in a situation-dependent manner and/or dynamically, for example depending on the driving context. By way of example, the first time interval and/or the second time interval can be defined as follows:

starting from or until the next vehicle to be overtaken, and/or

starting from or until a next (defined) maneuver, and/or

starting from or until the next traffic node, e.g. until the next exit, intersection, traffic cycle.

The abovementioned driving segments can correspond to the parts of a route that are defined in a determined way. By way of example, such driving segments can comprise the road sections or route sections between, e.g. between closest together traffic lights, places to yield, intersections, traffic circles, etc. In this case, the device can be configured, in response to an actuation of the accelerator pedal and/or brake pedal, to execute an abovementioned lateral control action (only) within the present driving segment, in particular in a suitable, in particular the best suited, part of the driving segment. By way of example, by means of an actuation of the accelerator pedal, it may be possible to stipulate that an overtaking maneuver is executed, wherein the overtaking maneuver is executed (only after predefined prerequisites have been fulfilled) in a suitable time interval and/or at a suitable location within the current driving segment. The driver therefore need not necessarily choose an optimum moment for a determined driving maneuver, e.g. while his/her vehicle is traveling behind a vehicle traveling slowly. Thus, many situations that overtax the driver or emotional wrong decisions can be avoided. In other words, with an actuation of the at least one pedal, a determined driving maneuver can be predefined or the execution of a “suitable” driving maneuver can be predefined, wherein a suitable driving maneuver for the accelerator pedal and for the brake pedal is chosen from respectively different lists of the driving maneuvers.

The device is preferably configured in this way to request that the at least one lateral control action be instigated, prevented or influenced, without directly controlling a quantitative parameter of the lateral control action with the pedal. In this case, with different actuations of the accelerator pedal and/or brake pedal, (in principle) different driving maneuvers or opposing driving maneuvers in terms of direction can also be instigated, prevented or influenced in a determined manner.

To put it another way, depending on the at least one variable representing the degree of automation and the at least one first condition upon an actuation of an accelerator pedal and/or brake pedal, an altered or a (in principle) different lateral control action, an opposing lateral control action in relation to a certain succeeding time interval or a certain upcoming driving segment is instigated, prevented or influenced (in a determined manner).

Preferably, the device or the vehicle is configured in such a way that an actuation of the accelerator pedal and/or the brake pedal in at least one determined driving mode are interpreted in such a way that a lateral control action is thereupon instigated, prevented or influenced. Such a driving mode can be e.g. between at least two values of the variable representing the degree of automation.

In a further advantageous configuration of the invention, the effect desired by the driver and instigated in this way in relation to the at least partly automated lateral control action of the vehicle is executed only in an ascertained time interval (and if permitted by the conditions, e.g. after 5, 10, 30, 60 or 120 seconds). Particularly preferably, the pedal operation leading to an alteration of the meaning, in a partly automated driving mode, does not lead to a take-over of the operator control by the driver lead.

In an additional or alternatively applicable example, the at least one pedal of the vehicle is utilized for instigating, preventing or for influencing a lateral maneuver action depending on the at least one variable representing the degree of automation, in particular between the at least two values of said variable, in a partly automated mode. Such a partly automated mode can be identified by determined driver information to be output upon a transition to the partly automated driving mode being made or upon the partly automated driving mode being left.

By way of example, in response to the actuation of the accelerator pedal and/or the brake pedal, a lateral control action is executed, prevented or instigated (within a succeeding, predefined time interval) only if permitted by the traffic conditions. In particular, at least one optimum or optimized point in time is ascertained and said lateral control action is executed only at that point in time or until that point in time.

In a simplified example, e.g. in response to:

a pressure (once) on the accelerator pedal, a lane change maneuver and/or an overtaking maneuver are/is instigated at the next opportunity, and/or in response to

a pressure (once) on the brake pedal, an (imminent or probable) lane change maneuver and/or an overtaking maneuver are/is suppressed or shifted in time, e.g. to the next opportunity.

This affords the very important advantage that a driver accustomed to conventional manual driving cannot make a critical error. Said driver does not need to remember a specific complex set of regulations or be specially trained. Moreover, a person who is not entitled to undertake manual driving can concomitantly operate the vehicle with the at least one pedal. In this case, there is no need for abilities (which are required certain driving practice) for controlling or regulating the vehicle guidance.

As already mentioned in the introduction, the device can have a driving mode for modifying the lateral control of the vehicle on account of the actuation of the accelerator pedal and/or the brake pedal, and the vehicle or the device can be configured in such a way that a transition is made to said driving mode for modifying the lateral control of the vehicle with an accelerator pedal and/or the brake pedal depending on the at least one variable representing the degree of automation and/or at least one first condition and/or the at least one second condition. In particular, the device can have a driving mode for modifying the lateral control of the vehicle on account of the actuation of the accelerator pedal and/or the brake pedal (in which the lateral control action of the vehicle with the brake pedal and/or the accelerator pedal is instigated, prevented or modified), and a transition of the device to said driving mode from an at least highly automated mode and/or from a substantially manual mode takes place depending on at least one first condition and/or on at least one second condition.

Particularly preferably, the driving mode for modifying the lateral control of the vehicle with an accelerator pedal and/or brake pedal is identified depending on or in connection with a state (cf. for example a so-called finite state machine, Petri net, etc.) or a current driving mode and/or a corresponding effect in relation to the at least partly automated control of the vehicle is instigated. The driving mode for modifying the lateral control of the vehicle with an accelerator pedal and/or the brake pedal can be a determined partly automated driving mode of the device or of the vehicle.

Preferably, the driving mode for modifying the lateral control of the vehicle with an accelerator pedal and/or the brake pedal can be identified and/or activated depending on a transition by the vehicle and/or the device to a predetermined partly automated driving mode and/or can be canceled depending on a transition by the vehicle and/or the device from a predetermined partly automated driving mode, for example to a substantially manual driving mode or to a highly automated mode.

Preferably, a transition by the vehicle and/or the device from a highly automated driving mode or a manual driving mode to the driving mode for modifying the lateral control of the vehicle with an accelerator pedal and/or brake pedal can be effected depending on the at least one first condition and/or a transition by the vehicle and/or pedal system from the modified further driving mode to a highly automated driving mode or manual driving mode can be effected depending on the at least one second condition.

Particularly preferably, said driving mode for modifying the lateral control of the vehicle with an accelerator pedal and/or brake pedal is one of at least two driving modes, preferably one of three driving modes, wherein in particular the device can select or assume said driving mode depending on the variable representing the degree of automation. Preferably, the vehicle or the device is configured with a substantially manual driving mode, said driving mode for modifying the lateral control of the vehicle with an accelerator pedal and/or the brake pedal, and a highly automated or substantially automatic mode.

In said driving mode for modifying the lateral control of the vehicle with an accelerator pedal and/or the brake pedal, the interpretation of the actuation of the accelerator pedal and/or brake pedal can correspond to a modified logic (in comparison with the at least one substantially manual mode). In this case, it is possible to differentiate for example between a short pressure, long pressure, a strong pressure, a weak pressure or combinations thereof. Afterward, it is possible to implement different interpretations with respect to instigating, preventing or modifying the at least one lateral control action.

In a further expedient configuration, the transition to the driving mode for modifying the lateral control of the vehicle with an accelerator pedal and/or the brake pedal can be dependent on a necessity established by further means of the vehicle and/or a hazard potential and/or an action recommendation to carry out a determined driving maneuver. A driving maneuver can be (strong) braking or (strong) acceleration, for example for an overtaking maneuver, a filtering operation or a required braking operation. Generally, a driving maneuver can be an arbitrary driving maneuver which requires or necessitates an intervention in longitudinal control of the vehicle. By way of example, a driving maneuver can be an overtaking maneuver, lane change maneuver, turning maneuver, orienting maneuver and/or parking maneuver. In association therewith it is expedient to output information to the driver of the vehicle concerning a corresponding driving maneuver and/or with a corresponding action instruction.

In accordance with a further expedient configuration, the device is configured for ascertaining a measure of an anticipated success of at least one determined driving maneuver, in particular in relation to the present traffic situation and/or prevailing conditions within or outside the vehicle, wherein instigating, preventing or influencing at least one driving maneuver comprising lateral control is dependent on an ascertained measure of the anticipated success of the driving maneuver.

In this case, in particular using further means of the vehicle it is possible to determine a measure of an anticipated success of a determined driving maneuver, in particular in relation to the present traffic situation and/or prevailing conditions within or outside the vehicle. Such an anticipated success can be ascertained depending on probability values for success, failure or termination of a driving maneuver. The device can ascertain the corresponding information, or information corresponding to the measure of an anticipated success of the determined driving maneuver, in particular by means of read-in.

In accordance with a further expedient configuration, the at least one second condition for the accelerator pedal and the brake pedal comprises a transfer request regarding the longitudinal control and/or lateral control of the vehicle that is to be carried out by the driver. The transfer request can be generated by way of means of the vehicle, e.g. the system for at least partly automated driving, and/or can be communicated to the driver via a human-machine interface. This can be done e.g. depending on a decrease in the degree of automation that has taken place or is expected, and/or depending on the currently prevailing traffic situation.

The transfer request can be a so-called take-over request (TOR) or a hands-on request (HOR) or an explicit request to operate a determined pedal and/or the steering wheel of the vehicle. In the case of an HOR, the driver is requested to apply hands and/or feet to relevant operator control elements in order to be able to make corrective interventions, if appropriate.

Such a procedure can be expedient if there is a need to carry out a “significant driving task” in relation to longitudinal and/or lateral control of the vehicle. Such a significant driving task can be an additional acceleration or deceleration of the vehicle which is desired by the driver and is implemented in relation to an acceleration or deceleration already effected by the at least partly automated driving and which is to be carried out or performed in addition or in relation to the acceleration or deceleration determined by the vehicle automation.

An additional acceleration or deceleration can be superimposed additively, multiplicatively or logarithmically on the acceleration already requested by the driving automation. The second condition can be dependent on an urgency of the transfer request or a criticality of a current or shortly expected traffic situation.

In accordance with a further expedient configuration, the at least one second condition for the accelerator pedal and/or for the brake pedal comprises the transfer request with respect to a lateral control of the vehicle that is to be carried out by the driver of the vehicle currently or in the future, in particular readiness for steering and/or a steering action on the steering wheel of the vehicle. The second condition is established if a steering wheel sensor detects a gripping force and/or a determined steering action. Readiness for steering can be detected by means of a so-called hands-on sensor on the steering wheel and/or with the aid of a camera arranged in the interior of the vehicle. Such sensors, e.g. on a capacitive basis, are known to the person skilled in the art. The steering action can be recognized by means of a steering angle sensor or a steering force detection.

The second condition is present, for example, if an increased wraparound force exceeding a determined measure on the steering wheel, e.g. at one or two locations of the steering wheel, is established and a simultaneous force action on one of the pedals by the driver's foot is established.

In the context of this description, steering wheel can also be understood to mean a (non-round) operator control element, e.g. a joystick, for controlling the steering or lateral dynamics of the vehicle.

In accordance with a further expedient configuration, the at least one first condition and/or the at least one second condition are/is dependent on an attention state of the driver. The attention state can be a general attention state of the driver that is ascertained by way of means of the vehicle. By way of example, an interior camera that detects the driver of the vehicle can be used for this purpose. In the case of the attention state, it is possible to differentiate between attention by way of different sensory perceptions and perception channels of the driver. It is expedient for a differentiation to be effected with respect to the determined roadway regions and/or objects to which this relates. Objects can be understood to be currently relevant road users, a vehicle in front of the ego vehicle or else a vehicle traveling behind the ego vehicle.

In accordance with a further expedient configuration, the device is configured to vary the instigating, preventing, or influencing of the at least one lateral control action of the vehicle with the accelerator pedal and/or with the brake pedal depending on current and previous monitoring of determined spatial regions in the vicinity of the vehicle. As a result, a check can additionally be made to establish whether the driver actually is looking or has looked at the roadway before a variation of the representation of the pedal actuation or a transition of at least one pedal to a manual mode is effected. In this regard, e.g. by means of eye tracking it is possible to check whether the driver has looked at a roadway region and/or an object on the roadway or in the rear-view mirror, which is relevant to carrying out an acceleration or braking.

A further expedient configuration provides for the second condition of at least one of the pedals to be dependent on the preceding first condition of the same pedal and/or of the respective other pedal.

In order to achieve the object, furthermore, a vehicle comprising means for modifying the lateral control for at least partly automated driving and a pedal system is proposed, wherein the device is configured in accordance with the description above. The vehicle has the same advantages as have been explained above in connection with the pedal system according to the invention.

The invention furthermore proposes a method for modifying lateral control of a vehicle configured for at least partly automated driving, comprising the following steps:

detecting an actuation of the accelerator pedal and/or the brake pedal,

detecting or predicting a variable of the travel of the vehicle, said variable representing the degree of automation, upon detected actuation of the accelerator pedal and/or brake pedal, and

executing, preventing or influencing an automated lateral control action of the vehicle depending on a variable representing the degree of automation.

The method can furthermore be configured in accordance with the above description.

Finally, a computer program product is proposed which can be loaded directly into the internal memory of a digital computer and comprises software code sections with which the steps of the method described here are carried out when the product runs on the computer.

The computer is, in particular, a computing unit of the vehicle. The computer program product can be stored on a storage medium, such as e.g. a USB memory stick, a DVD, a CD-ROM, a hard disk or the like. The computer program product can likewise be transmittable via a communication connection (wireless or wired).

The method according to the invention has the same advantages as have been described above in connection with the device according to the invention.

The device according to the invention allows effective concomitant control of the vehicle during automated travel by the driver, without the active driver assistance function having to be switched off or having to be interrupted for a significant time interval. This results in a significant increase in convenience and intuitive operator control for the driver. In this case, an abovementioned lateral control action of the vehicle or control of the vehicle comprising lateral control and longitudinal control, by means of a foot of the driver, can also be instigated, prevented or modified (in a determined manner).

The invention enables a vehicle configured for at least partly automated driving to be concomitantly controlled if appropriate in a necessary way, in an expedient way or in a way desired by the driver. In this case (depending on boundary conditions, driver's desire, etc.) only or as well the lateral control of the vehicle can be modified, in particular in the sense of participation on the part of the driver. This can be implemented only by means of a foot of the driver or by means of a pedal of the device.

The invention makes it possible to implement a multiplicity of the functions utilizable in the vehicle and/or services in the vehicle, e.g. depending on the driving mode with the abovementioned driving mode or the influencing of the lateral control. An economically relevant advantage afforded is that during driving operation of the vehicle the driver's hands can be freed to carry out further activities (for a significantly longer time or to a greater extent than otherwise). This opens up the possibility of offering a multiplicity of further services and functionalities.

Further services and functionalities can thus be offered even in the case of vehicles which are not configured or equipped for highly automated or autonomous driver, and/or on driving segments or in traffic situations which do not offer adequate conditions for highly automated driving. Preferably, the instigating, the active offering or modifying of further services or functionalities in the vehicle can be implementable depending on the abovementioned driving mode for modifying the lateral control of the vehicle or on the driving mode with the modified meaning of the actuation of at least one pedal or on the abovementioned partly automated driving mode.

Further services and functionalities can comprise for example productive activities, such as e.g. office work, communication, infotainment, gaming or sporting activity. The abovementioned services and functionalities can be activatable and/or actively offered depending on the transition to the abovementioned driving mode. When the partly automated driving mode is left, e.g. in a transition to a substantially manual driving mode, determined services or functionalities can be deactivatable, be utilizable only in a modified form (e.g. form requiring reduced use of at least one hand of the driver or less attention), or be configured as automatically pausible.

Furthermore, depending on the corresponding driving mode for modifying the lateral control of the vehicle on account of the actuation of the accelerator pedal and/or the brake pedal and/or a transition to the abovementioned driving mode or from the abovementioned driving mode, it is possible to instigate a changeover of an operating mode of an interface for human-machine communication or a display/operator control concept of the vehicle or of further equipment utilizable in the vehicle.

Furthermore, a vehicle comprising the abovementioned device or functionality can be brought to market significantly faster, even before all the prerequisites required for highly automated or automatic operation have been satisfied. Moreover, by virtue of the device, a portion of other means of the vehicle, e.g. of a very complex high-quality sensor system and/or computing unit otherwise required, can be developed and produced according to less stringent technical requirements. Furthermore, a (traditional) heavy, expensive—and occupying a determined volume—steering wheel of the vehicle can also be obviated or significantly simplified.

The invention makes it possible to provide a new corresponding kind of operator control of the vehicle and/or a driving experience based thereon as a product. The latter can be offered e.g. as a vehicle function or a service. By way of example—insofar as permissible—a transport service or collection service with a vehicle or method according to the invention could also be offered for persons who are not generally entitled to drive.

The vehicle is, in particular, a motor vehicle (automobile, truck, transporter or for instance a two-wheeler, e.g. a motorcycle). This gives rise to a number of advantages, described in this document, and further advantages that are straightforward for comprehension by the person skilled in the art. Furthermore, the vehicle can also be a watercraft or aircraft or spacecraft, wherein the device, mutatis mutandis, is configured analogously.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic illustration of an exemplary device according to the invention for a vehicle configured for at least partly automated driving.

FIG. 2 is a simplified state diagram illustrating the functioning of the device or method in accordance with one configuration example.

### DETAILED DESCRIPTION OF THE DRAWINGS

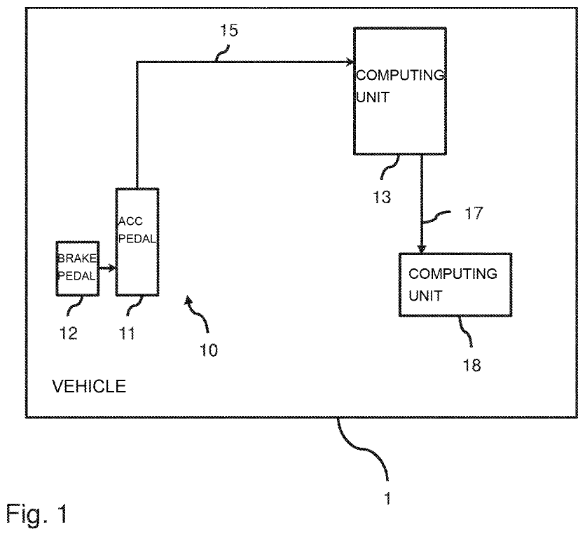

FIG. 1 shows a device 10 according to the invention comprising a pedal system (or a device configured as a pedal system) for modifying the lateral control of a vehicle 1 configured for at least partly automated driving. By way of example, the device 10 comprises a pedal system, an accelerator pedal 11 and a brake pedal 12. Alternatively, the device could comprise a universal pedal for controlling the acceleration and deceleration of the vehicle 1. In principle, any operator control element that is also suitable for continuously variably controlling the lateral control of the vehicle with one hand can be understood as a pedal system within the meaning of the invention. This last is known by the term “hand throttle”. Moreover, an accelerator pedal 11 and/or brake pedal 12 can be configured as an operator control element having at least two actuation regions of a pedal system, which are arranged for example on the right or left with respect to one another. Such actuation regions can be chosen e.g. alternately by means of a foot of the driver.

The at least one pedal 11 and/or 12 (or the operator control element) is a pedal or operator control element which is movable or effectively controllable exclusively or substantially in accordance with only one degree of freedom (degree of freedom of movement). In the case of a conventional pedal 11 and/or 12, such a degree of freedom is the (variable) pedal angle, for example. Preferably, the pedal 11 and/or 12 (or the operator control element) per se is not suitable for implementing a mechanical rotation (expediently utilizable for controlling the vehicle 1) in the transverse direction or for implementing a mechanical transverse offset for aligning the vehicle 1.

Furthermore, an important part of the invention is that determined aspects of the achievable or suitable degree of automation are individually ascertained, in particular predicted.

In this example, the device 10 is configured to ascertain, for example to read in, a variable representing the degree of automation. In this example, one or a plurality of such variables is/are ascertained. In this case, at least one of the variables representing the degree of automation relates to an upcoming driving segment, e.g. to the driving segment along the planned or probable route of the vehicle 1.

In a simplified example, the gradations of the degree of automation that are known from the prior art can be taken into account in this case. By way of example, it is possible to take account of those gradations of the degree of automations which have been defined by the German Federal Highway Research Institute (BASt) (see BASt publication “Research Compact”, issue 11/2012): in the case of assisted driving, the driver permanently carries out the longitudinal or lateral control, while the system performs the respective other function within certain limits. In the case of partly automated driving (PAD), the system performs the longitudinal and lateral control for a certain period of time and/or in specific situations, wherein the driver must permanently monitor the system as in the case of assisted driving. In the case of highly automated driving (HAD), the system performs the longitudinal and lateral control for a certain period of time, without the driver having to permanently monitor the system; however, the driver must be able to take over control of the vehicle within a certain time. In the case of fully automated driving (FAD), the system can automatically manage driving in all situations for a specific application; a driver is no longer required for this application. The four degrees of automation in accordance with the definition by the BASt as mentioned above correspond to SAE Levels 1 to 4 of the SAE J3016 standard (SAE—Society of Automotive Engineering). By way of example, highly automated driving (HAD) in accordance with the BASt corresponds to Level 3 of the SAE J3016 standard. Furthermore, the SAE J3016 also provides SAE Level 5 as the highest degree of automation, which is not contained in the definition by the BASt. SAE Level 5 corresponds to driverless driving, wherein the system can automatically manage all situations like a human driver during the entire journey; a driver is generally no longer required.

The at least one variable representing the degree of automation can (furthermore) represent different aspects of the degree of automation. By way of example, diverse qualitative and/or quantitative variables of the degree of automation can expediently be taken into account. In particular, this involves such aspects of automation which can be activated or operated at least partly independently of one another. By way of example, the variable representing the degree of automation can be related to:

longitudinal control of the vehicle and/or

lateral control of the vehicle and/or

implementability of a lane change and/or

implementability of an overtaking operation and/or

implementability of joining the interstate highway

implementability of leaving the interstate highway

implementability of an automated turning maneuver, etc.

A variable representing the degree of automation can for example also be related to a driving maneuver (initially applicable as possible or a possibly desired or expedient applicable driving maneuver) or a determined driving maneuver possibly imminent.

In particular, modifying the lateral control of the vehicle 1 on account of the actuation of the accelerator pedal 11 and/or the brake pedal 12 is effected within or only within certain limits of the at least one variable representing the degree of automation. Preferably, this involves modifying the lateral control of the vehicle 1 in accordance with a tendency predefinable by the actuation of the accelerator pedal 11 and/or the brake pedal 12 by the driver. Said tendency can denote e.g. a tendency toward a rather offensive driving maneuver executable in an at least partly automated manner or toward a rather defensive driving maneuver executable in an at least partly automated manner. By way of example, in response to the actuation of the accelerator pedal 11 and/or brake pedal 12, a driving maneuver executable in an at least highly automated manner e.g. from a list of possible, executable or permitted driving maneuvers can be instigated, wherein the driving maneuver is determined depending on the tendency predefinable by the driver. The tendency can be chosen e.g. by means of the selection of the pedal 11 or 12 and by means of one or more parameters of the actuation of the at least one pedal 11 or 12. By way of example, the driver, even if his/her hands are occupied or not on the steering wheel or if the steering wheel of the vehicle is retracted, locked or not present, can thus decide (almost instantaneously) about a further course of highly automated travel with the accelerator pedal 11 and/or brake pedal 12, without interrupting the highly automated travel in the process.

In this example, with at least one accelerator pedal 11 and/or brake pedal 12, instigating, preventing or modifying a lateral control action is operable by the driver. By way of example, the device or the method can be configured in such a way that with a short actuation of the brake pedal 12, which actuation has no or no significant effect on the longitudinal control of the vehicle 1, an alteration of the meaning is instigated in the first time interval and an overtaking maneuver executable by way of means of the vehicle (within the present driving segment) will prevent lateral control in a second, later time interval.

The device 10—comprising a pedal system—can for example also be a distributed system of the vehicle, comprising the so-called pedal module and/or at least an accelerator pedal 11 and/or a brake pedal 12, or be a universal pedal. What is important in the invention is the abovementioned vehicle functionality corresponding to features described in this document, and also the manner of operating the control of the vehicle by way of a driver's foot.

The device 10 is configured to execute, prevent or influence an automated lateral control action of the vehicle during operation of the vehicle 1 upon actuation of the accelerator pedal 11 and/or the brake pedal 12 depending on a variable of the travel of the vehicle 1, said variable representing the degree of automation.

For this purpose, depending on a respective position and/or dynamic movement of the accelerator pedal and/or brake pedal 11, 12, corresponding signals 15, 16 are transmitted to a computing unit 13 of the device 10. The signal 16 represents the position and/or movement of the accelerator pedal. The signal 16 represents the position and/or movement of the brake pedal. The computing unit 13 is connected to a storage unit 14, in which are stored one or more interpretation variants for the meaning of the actuation of the accelerator pedal 11 and/or brake pedal 12 and control parameters for the longitudinal control and/or lateral control of the vehicle 1. The computing unit 13 is configured to read out from the storage unit 14 the alteration possibility/-ies—contained in the storage unit 14—for the meaning of the actuation of the accelerator pedal 11 or brake pedal 12, to process it/them and, as the result of the processing, to transmit a control parameter 17 to a further computing unit 18 for executing the longitudinal and/or lateral control of the vehicle. The computing unit 18, for its part, belongs to the systems (e.g. actuators, sensors and the like)—not illustrated in more specific detail in the figure—for at least partly automated driving of the vehicle 1 or is connected to said systems.

In this case, different actuations of the accelerator pedal 11 and/or brake pedal 12 can comprise determined pressure patterns and/or pressure sequences. Preferably, at least one actuation of the accelerator pedal 11 and/or of the brake pedal 12 or a differentiation of the at least two actuations of the accelerator pedal and/or brake pedal is recognized by means of pattern recognition. In this case, the pattern recognition can be applied to at least one parameter, preferably to at least two parameters, of the actuation of the at least one pedal or the operator control element, for example to pedal angle, pedal pressure, a time-dependent function, e.g. time profile of the pedal angle or pedal pressure. Furthermore, at least one actuation of the accelerator pedal 11 and/or the brake pedal 12 or a differentiation of the at least two actuations of the accelerator pedal 11 and/or brake pedal 12 can be recognized on the basis of a determined pressure sequence. By way of example, on the basis of the recognition of a determined pattern or pressure sequence, a determined meaning of the operation of the accelerator pedal 11 and/or the brake pedal 12 is identified if the vehicle is in the abovementioned driving mode for modifying the lateral control of the vehicle 1 on account of the actuation of the accelerator pedal 11 and/or the brake pedal 12. By way of example, in the abovementioned driving mode for modifying the lateral control of the vehicle 1 on account of the actuation of the accelerator pedal 11 and/or the brake pedal 12 or in a highly automated mode, actuation of the accelerator pedal 11 and/or brake pedal 12 twice or three times can be allocated a determined meaning. By way of example, in this case, one or a plurality of actuations of the accelerator pedal 11 and/or brake pedal 12 is/are allocated a meaning which differs (in principle) for instance from a meaning of the actuation of the accelerator pedal and/or the brake pedal in a substantially manual driving mode.

Particularly preferably, an actuation of the accelerator pedal and brake pedal in a determined order and/or sequence and/or at least partly simultaneous actuation of the accelerator pedal 11 and the brake pedal 12, in particular simultaneous actuation of the accelerator pedal 11 and/or brake pedal 12, which exceed determined parameter limits, can correspond to a determined meaning. By way of example, simultaneous actuation of the accelerator pedal 11 and brake pedal 12 can be assigned to a handover of the execution, e.g. to the handover of control of the execution of at least one driving maneuver, in particular a determined or an imminent driving maneuver, to the vehicle and/or to a handover of control of the execution of at least one determined or imminent driving maneuver by the driver.

A parameter of the actuation of the accelerator pedal 11 and/or brake pedal 12 is detectable and evaluatable by the pedal system 10. Depending on the parameter or on the evaluation of the at least one parameter, it is possible to influence the type of lateral control action to be executed, the type of lateral control action, in particular the type of driving maneuver, the urgency (for instance as a time parameter with respect to the execution or for instance a deadline with respect to the execution) and/or the importance with which these should thereupon be executed, prevented or influenced.

By way of example, a (particularly or exceptionally) fast and/or strong pressure on the accelerator pedal can be interpretable such that a lateral control action should be executed as soon as possible or that a type of lateral control action, in particular of a determined lateral control action, or a determined driving maneuver (e.g. high ranking in the list of such driving maneuvers) is permitted to be executed or ought to be executed urgently or rapidly. In this regard, by way of example, the selection of a time interval in which a driving maneuver instigated with the actuation of the accelerator pedal 11, e.g. a lane change maneuver or overtaking maneuver, is executed or modified can be determinable depending on an actuation parameter of the accelerator pedal.

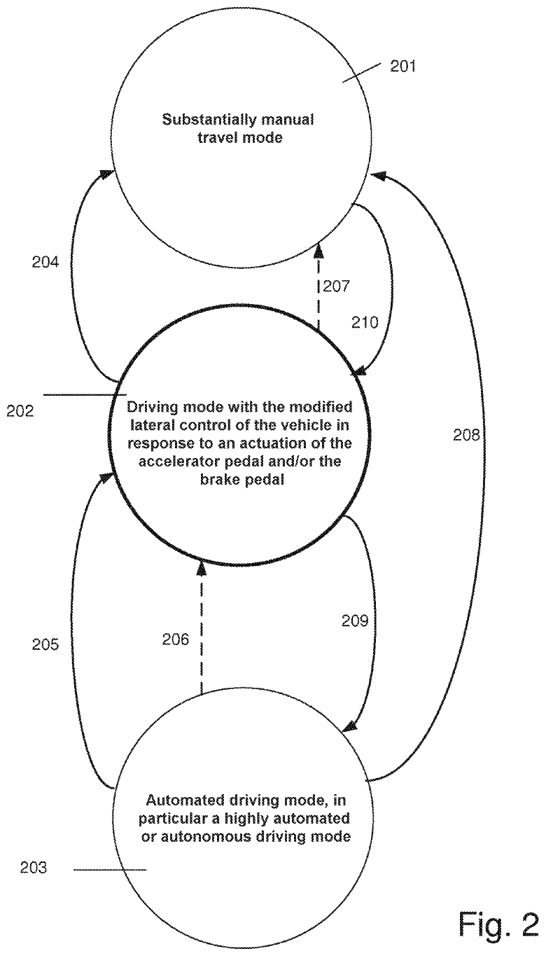

FIG. 2 shows one exemplary embodiment in the form of a simplified state diagram.

A first state is designated by the reference sign 201, a second state by 202, and a third state by 203. The reference signs 204, 205, 206, 207, 208 and 209 210 represent state transitions between the different states 201, 202 and 203. The states 201, 202 203 can be regarded as states of the device 10 which are dependent on or connected with the corresponding driving modes of the vehicle 1. Moreover, the corresponding states of the device 10 can predefine the corresponding driving modes of the vehicle 1, be dependent on the corresponding driving modes of the vehicle or be in a predefined relationship with one another.

The first state 201 represents a first state with a, for the most part or substantially, manual travel mode for acceleration and/or deceleration control by the driver with the aid of at least one pedal. Either no support or only support by already customary driver assistance systems for longitudinal or lateral control is permitted in this state 201.

The second state 202 represents, according to the invention, a second state with a driving mode 202 for modifying the lateral control of the vehicle 1 on account of the actuation of the accelerator pedal 11 and/or the brake pedal 12. Modified lateral control can be understood to mean executing, preventing or influencing an automated lateral control action of the vehicle by means of the accelerator pedal and/or the brake pedal. In this case, an actuation (a permanent actuation corresponding to the duration of the lateral control action) of the accelerator pedal or the brake pedal need not be effected.

The driving mode 202 for modifying the lateral control of the vehicle 1 on account of the actuation of the accelerator pedal 11 and/or the brake pedal 12 or the corresponding state 202 of the device and/or a transition to the state 202 or from the state 202 can be modifiable depending on traveling along or approaching defined driving segments, road types or traffic situations. By way of example, if a driving segment which is not approved for a highly automated driving mode 203 is approached, said driving mode 202 for modifying the lateral control of the vehicle 1 on account of the actuation of the accelerator pedal 11 and/or the brake pedal 12 can be activated or be made activatable (instead of a switchover to a substantially manual mode 201). This affords a major advantage for the driver in comparison with “discarding” the driving automation. The driving mode 202 with the modified lateral control of the vehicle 1 on account of the actuation of the accelerator pedal 11 and/or the brake pedal 12 can be executable or made available within or only within determined position limits of the respective pedal 11 and/or 12. In this case, the one or two position limits can relate to the actuation and/or mobility of the accelerator pedal 11 and/or the brake pedal 12. Moreover, it is possible to determine the one or two position limits in response to the actuation and/or mobility of the accelerator pedal 11 and/or the brake pedal 12 depending on or in association with a transition by the device 10 to said driving mode 202.

The third state 203 represents a third state with an automated driving mode, in particular a highly automated or autonomous driving mode.

The various state transitions 204 to 210 are explained in greater detail below.

Proceeding from the first state 201, either a state transition (not illustrated in the figure) to a highly automated mode 203 or a state transition 210 to said driving mode 202 for modifying the lateral control of the vehicle on account of the actuation of the accelerator pedal 11 and/or the brake pedal 12 takes place. Such a transition can for example also be effected depending on an operator control action on the part of the driver and/or depending on further prerequisites and the features described in this document.

Proceeding from the third state 203, a state transition 205 to the second state takes place. The device is configured to instigate or to perform the state transition 205 if e.g. the current value of the variable representing the degree of automation and/or a (for an upcoming time interval and/or driving segment) predicted and/or desired value of the variable representing the degree of automation undershoots a determined threshold value. Alternatively or additionally, this state transition can be instigated if a transfer request and the driver's gripping of the steering wheel are detected.

The device is furthermore configured, in the or depending on the abovementioned state 202, to interpret the actuation of the accelerator pedal and/or the brake pedal (in principle) differently than in the predominantly or substantially manual mode 201. Depending on the state 202 or the transition to the state 202, depending on the actuation of the accelerator pedal 11 and/or the brake pedal 12 modifying the lateral control of the vehicle in response to the actuation of at least one pedal can be effected in accordance with one or more features described in this document.

Furthermore, proceeding from the third state 203, a state transition 208 to the first state 201 takes place if a transfer request and gripping of the steering wheel with two palms and/or gripping of the steering wheel and a steering action or a combination of force actions on the part of the driver, e.g. a torsion action on the gripped surfaces of the steering wheel, are detected. In this case, it is also possible to define an alternative further transfer request 208 for transition to a substantially manual mode 201.

The device is configured to ascertain the conditions of the state transition 205 depending on conditions, variables and features described in this document. By way of example, the state transition 205 can be instigated depending on an operator control action and/or depending on reaching a new driving segment, e.g. a crossing or exit to a further road.

In this example, the device is configured to differentiate the conditions of the abovementioned state transition 205 from the conditions of the abovementioned state transition 208.

If, proceeding from the third state 203, a redundant second condition for canceling the state 202 occurs, then the state transition 206 to the second state 202 is effected, i.e. the state transition 206 enables a transition from the third state 203 to the second state 202 with the aid of a redundant second condition, e.g. in the event of discarding or failure of the automation.

Proceeding from the second state 202, a state transition 209 to the third state 203 takes place if it is established that the driver has fallen asleep or if the driver is incapable of driving and at the same time an urgent action on the part of the driver is not required. Proceeding from the second state 202, a state transition 204 to the first state 201 takes place if a corresponding driver's desire for a change to the manual driving mode or a transfer request is detected, and at the same time corresponding means (alertness recognition, eyes-on recognition) establish that the driver is capable of driving.

If, proceeding from the second state 202, a redundant second condition for canceling the modified lateral control by executing, preventing or influencing an automated lateral control action or the abovementioned driving mode corresponding to the state 202 occurs or discarding/failure of the automation is recognized, then the state transition 207 to the first state 201 is effected, i.e. the state transition 207 enables a transition from the second state 202 to the first state 201 with the aid of a redundant second condition, e.g. in the event of discarding or failure of the automation.

In one preferred example, the state transitions 209 and/or 210 can be implementable depending on the at least one first condition, and/or the state transitions 205 and/or 204 can be implementable depending on the at least one second condition. In this case, the state transitions 204 and 205 can be differentiable for example on the basis of a quantitative and/or qualitative difference in the parameters or parameter values of the abovementioned second condition. In this case, the state transitions 210 and 209 can be differentiable for example on the basis of a quantitative and/or qualitative difference in the parameters of the abovementioned first condition.

The abovementioned states 201, 202, 203 can represent e.g. states of a so-called finite state machine. Said states can be dependent on analogously corresponding states of vehicle operation. Furthermore, the features of the invention that are described here by means of the states 201, 202, 203 can alternatively e.g. also be ascertainable or able to be brought about by means of a predefined formula. In this case, the effect of the abovementioned features of the states 201, 202, 203 can be able to be brought about discretely in time, in stages or continuously, e.g. within a few seconds after the recognition of a corresponding first and/or second condition for the state transition 204, 205, 206, 207, 208, 209 and/or 210. Furthermore, in the states 201, 202, 203 or upon various state transitions 204, 205, 206, 207, 208, 209 and/or 210, in each case determined driver information can be output or the outputting of determined driver information can be instigated.

By way of example, depending on a transition to the state 202, it is possible to instigate the outputting of driver information which is characteristic of the fact that a further service or function, in particular a determined service or a determined function, is activatable or utilizable, in particular in a determined manner, and/or that the hands of the driver (i.e. the person in the driver's position) can be utilized for a further activity or kind of activity, in particular for a determined activities, in particular in a determined manner and/or with determined restrictions.

As an alternative or in addition to the features described in this document, the vehicle can comprise at least two pedals or actuation regions of a pedal system, wherein in response to an actuation of a pedal or actuation region of the pedal system that is arranged on the right, a driving maneuver comprising a lateral control action, e.g. turning off toward the right, exiting toward the right, evasive action toward the right or a lane change toward the right, is instigated, and in response to an actuation of the pedal or actuation region of the pedal system that is arranged on the left, a driving maneuver comprising a lateral control action, e.g. turning off toward the left, exiting toward the left, evasive action toward the left or a lane change toward the left, is instigated. In this case, the at least one lateral control action can be executed only upon the fulfillment of a further predetermined condition, e.g. the next possibility to carry out the desired lateral control action.

The vehicle or the device can generally also be configured only for operation or substantially for operation in the states 202 and 203 or only for operation or substantially for operation in the states 202 and 201. By way of example, a taxi or rental or replacement vehicle which is drivable in a highly automated manner is conceivable which in particular no longer has a traditional steering wheel and is drivable substantially in a highly automated manner, wherein the substantially highly automated travel is modifiable with the accelerator pedal and/or brake pedal, in accordance with one or more features of the invention.

Furthermore, the pedal system can be configured, with a determined actuation of the at least one accelerator pedal and/or brake pedal within a state 202 or within an at least partly automated driving mode, depending on further conditions described in this document, to control, e.g. to instigate or to prevent, further functions or services—not related to the driving task.

The invention enables the driver's hands to be freed of driving tasks. In this case, the hands can be utilized e.g. for carrying out productive tasks, communication, leisure activity or use of functions and services and/or utilization of diverse further devices, e.g. mobile user devices. At the same time the driver is afforded a possibility of exercising a determined, necessary or desired influence on one or more lateral control actions of the vehicle 1.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A device for modifying lateral control of a vehicle configured for at least partly automated driving, comprising:
an accelerator pedal and/or a brake pedal, wherein
the device is configured to execute, prevent or influence an automated lateral control action of the vehicle during operation of the vehicle upon actuation of the accelerator pedal and/or the brake pedal depending on a variable of travel of the vehicle, said variable representing a degree of automation.

2. The device according to claim 1, wherein
the automated lateral control action is part of a determined driving maneuver comprising lateral control of the vehicle, and
a type of driving maneuver and/or the automated lateral control action are determinable depending on a variable of the travel of the vehicle, said variable representing the degree of automation, and at least one first condition and/or at least one second condition.

3. The device according to claim 2, wherein
when the at least one second condition is present, the automated lateral control action comprising lateral control is prevented or executed in a modified form.

4. The device according to claim 3, wherein
the automated lateral control action is a determined driving maneuver of the vehicle.

5. The device according to claim 1, wherein
in response to an actuation of the accelerator pedal or the brake pedal in a first time interval, at least one automated lateral control action of the vehicle comprising either lane guidance of the vehicle or positioning of the vehicle relative to one or more lane markings or roadway boundaries, is executed, prevented or influenced during a second time interval, wherein the second time interval is after the first time interval.

6. The device according to claim 1, wherein
the device has a driving mode for modifying the lateral control of the vehicle on account of the actuation of the accelerator pedal and/or the brake pedal, and
a transition of the device to said driving mode from an at least highly automated mode and/or from a substantially manual mode takes place depending on at least one first condition and/or on at least one second condition.

7. The device according to claim 6, wherein
the at least one first condition and/or the second condition, or quantitative values taken as a basis for the corresponding first condition and/or second condition, for the accelerator pedal and the brake pedal are different.

8. The device according to claim 7, wherein
the transition to the driving mode for modifying the lateral control of the vehicle with an accelerator pedal and/or the brake pedal is dependent on a necessity established by: (i) further measures of the vehicle, (ii) a hazard potential, and/or (iii) an action recommendation to carry out a determined driving maneuver.

9. The device according to claim 1, wherein
the device is configured to ascertain a measure of an anticipated success of at least one determined driving maneuver, wherein instigating, preventing or influencing at least one driving maneuver of the vehicle comprising lateral control is dependent on the at least one ascertained measure of the anticipated success of the driving maneuver.

10. The device according to claim 9, wherein
the measure of the anticipated success of the at least one determined driving maneuver is made in relation to a present traffic situation and/or prevailing conditions within or outside the vehicle.

11. A method for modifying lateral control of a vehicle configured for at least partly automated driving, comprising:
detecting an actuation of an accelerator pedal and/or a brake pedal;
detecting or predicting a variable of travel of the vehicle, said variable representing a degree of automation, upon detected actuation of the accelerator pedal and/or brake pedal; and
executing, preventing or influencing an automated lateral control action of the vehicle depending on the variable representing the degree of automation.

12. A computer product comprising a non-transitory computer readable medium having stored thereon program code that, when executed by a processor, carries out the acts of:
detecting an actuation of an accelerator pedal and/or a brake pedal;
detecting or predicting a variable of travel of the vehicle, said variable representing a degree of automation, upon detected actuation of the accelerator pedal and/or brake pedal; and
executing, preventing or influencing an automated lateral control action of the vehicle depending on the variable representing the degree of automation.
